(19) United States
(12) Patent Application Publication
(10) Pub. No.: US 2012/0295693 A1
(43) Pub. Date: Nov. 22, 2012

(54) DYNAMIC SIGNATURE MANAGEMENT

(76) Inventors: Michael R. Bytnar, Naperville, IL (US); Ranjan Dasgupta, Naperville, IL (US); Craig J. Sylla, Round Lake, IL (US)

(21) Appl. No.: 13/472,723

(22) Filed: May 16, 2012

Related U.S. Application Data
(60) Provisional application No. 61/486,560, filed on May 16, 2011.

(51) Int. Cl. G06F 17/00

(52) U.S. Cl. 463/25; 463/43

(57) ABSTRACT

Apparatus, systems, and methods may operate to determine at least one signature associated with a static image stored in a storage medium housed within a wagering game machine operable to present a wagering game. Additional activity may include repetitively generating a signature image comprising a sorted list of signatures, some of the signatures in the sorted list being hardware signatures associated with a corresponding plurality of hardware components physically attached to the wagering game machine. Additional apparatus, systems, and methods are disclosed.

This application claims the benefit of priority under 35 U.S.C. 119(e) to U.S. Provisional Patent Application Ser. No. 61/486,560, filed on May 16, 2011, which is incorporated herein by reference in its entirety.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2011 WMS Gaming, Inc.

### BACKGROUND

Wagering game machine manufacturers and operators continually provide new and entertaining games. One way of increasing the entertainment value associated with casino-style wagering games (e.g., video slots, video poker, video black jack, and the like) includes offering a variety of base games and bonus events. However, despite the variety offered, players may still tend to lose interest. In order to maintain player interest, wagering game machine manufacturers frequently revise wagering game content, updating wagering game machines with new game themes, game settings, bonus events, game software, and other features.

As part of the very nature of wagering game play, currency in various forms is taken in, given out, and otherwise processed. To ensure that such processing occurs in the proper manner, the day-to-day operation of wagering games is carefully monitored and controlled. As a result, some of the controls implemented within casinos and other organizations may operate to scrutinize changes made to hardware and software components of wagering game machines, with the assistance of a variety of identification mechanisms, including signatures.

While signatures may constitute a useful way to account for the presence or absence of components that make up a given machine, managing a number of signatures in response to component changes can result in adding a noticeable delay to machine operations. These delays can be frustrating to casino operators, as well as to those that play wagering games.

### BRIEF DESCRIPTION OF THE FIGURES

Embodiments of the invention are illustrated by way of example and not limitation in the Figures of the accompanying drawings, in which:

FIG. 1 is a block diagram illustrating a wagering game machine architecture according to various embodiments;

FIG. 2 is a block diagram illustrating a wagering game network, according to various embodiments;

FIG. 3 is a flow chart illustrating methods according to various embodiments;

FIG. 4 is a perspective view of a wagering game machine, according to various embodiments;

FIG. 5 is a perspective view of a portable wagering game machine, according to various embodiments; and

FIG. 6 is a diagram of processes for signature generation, verification, and validation according to various embodiments.

### DETAILED DESCRIPTION

### Example Operating Environment

### Example Wagering Game Machine Architecture

Within a wagering game machine, individual digital signature calculations can take up to three minutes using current processing technology. The inventors have discovered that implementing a dynamic process for signature generation and management can result in significantly reducing processing delays.

Wagering game machines may comprise a number of hardware and software components. Software components may include images stored in memory. For example, in some machines, the BIOS ROM (basic input/output system read-only memory) and the SPI (serial peripheral interface) jurisdiction ROM constitute two physical components—in the form of separate integrated circuit memory devices. Other images accessible to the machine, either locally or remotely, include executable code for wagering games, operating system software, drivers for machine hardware components, etc. These images can be stored as a family of disk images, on a hard drive and/or in flash memory. Network sharing, storage area networks, or network-attached storage can also be used. For the purposes of this document, any one or more images resident in a wagering game machine may be used to form a “static image”.

In some embodiments, image signatures of the BIOS ROM and jurisdiction ROM are extracted. Then media signatures are extracted from selected images. The BIOS ROM, jurisdiction ROM, and media signatures are used to make up a signature list which can be sorted. In some embodiments (such as when a device signature is not associated with a file signature table), the unsorted list includes the BIOS ROM and jurisdiction ROM image signatures, individually or jointly wrapped in an empty or zeroed-out file signature table. In some embodiments, the signatures of the BIOS ROM and jurisdiction ROM images themselves are added to the beginning or the end of the signature list as part of a static ordering, after the list is sorted. At some point, duplicate signatures are eliminated, and the list is locked in the form of a file signature table to retain non-duplicate signatures in sorted order. In another embodiment, insertion of statically ordered signatures may be performed during the sorting phase. The order of operations to gather, insert, calculate, and sort may be independent, depending on the flexibility of the data structure used to store the final, ordered, and unique signature image.

An image may comprise any information that can be stored in media as a file, and is usable to expose a signature. The information may include coded instructions for a processor, firmware that is used to operate a related piece of hardware (e.g., a bill reader), or simply a number assigned to some hardware component of the machine that uniquely identifies that component. As an option, hardware components may be associated with unique identification information assigned by a manufacturer to form separate “signatures” for those components. These “hardware signatures” can be included in the file signature table as well.

The signatures in the table can be combined, perhaps using serial concatenation, according to their sorted order. The result is a binary file that uniquely identifies each of the components on the machine (associated with an individual signature) as a valid combination within that machine. The wagering game machine can use a seed value (e.g., provided by a trusted host, such as a regulatory agency) and the binary file as input to generate a single, comprehensive signature that can be used to quickly check whether changes have occurred within the machine. For example, a forty-byte hash of binary file that results from this process can be used in place of the comprehensive signature as a fingerprint for the associated gaming machine.

The signature image for each component in the machine can be separately uploaded to a host (e.g., a backend casino accounting system) from a trusted source (e.g., a regulatory agency, and not from the gaming machine itself). The host can operate to duplicate the binary file generation process using the same algorithm as the gaming machine, and the same seed value, to see if the same binary file and/or comprehensive signature can be derived. A mismatch might result in the gaming machine being put out of service by sending an out of service command from the host to the machine.

In some embodiments, the process of generating a binary file, and/or the comprehensive signature, may be accomplished within a wagering game machine on a periodic basic, such as every twenty-four hours, or more or less often, as desired. An associated wagering game server can check the periodically-generated binary file content against a master file accessible only to the server, if desired.

Operating wagering game machines in this manner can provide several benefits. For example, in a downloadable gaming software environment, wagering gaming machines can be queried using AOM (administration, operation, maintenance) appliances to determine what software has been installed, and the AOM appliance can then be used to manage content on the machine, generating a comprehensive signature based on what the machine reports as being installed. In this way, when content is changed dynamically, the AOM appliance can serve as a trusted source for verification of machine components. This type of operation also serves to eliminate another source of human error, being entirely under the control of the interconnected gaming machine and the AOM appliance. Examples of additional embodiments will now be described in further detail.

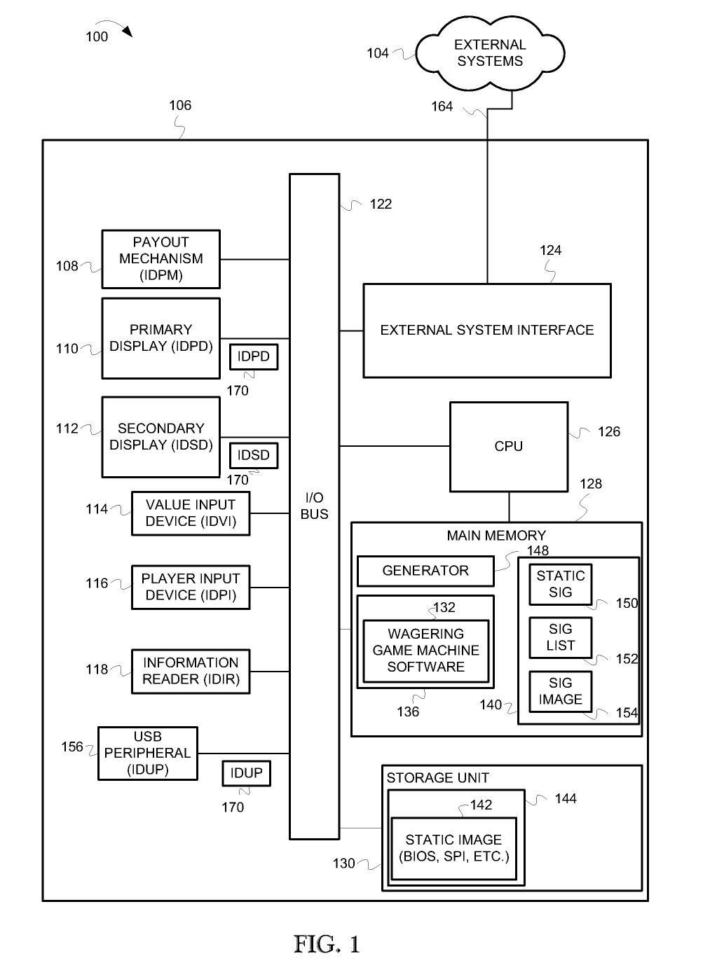

FIG. 1 is a block diagram illustrating a wagering game machine architecture 100 according to various embodiments of the invention. As shown in FIG. 1, an apparatus 106, such as a wagering game machine, includes a central processing unit (CPU) 126 connected to main memory 128, which in turn may include media images 132, such as wagering game machine software. The CPU 126 may include multiple processing cores, memory interface circuitry, a USB (universal serial bus) peripheral controller, and other elements.

The main memory 128 may be subdivided into portions, such as portions devoted to volatile memory 136 and non-volatile memory 140, and combinations thereof. The non-volatile memory 140 may comprise, in whole or in part, flash memory, phase-change memory, and read-only memory, among others. In many embodiments, the media images 132 include instructions which, when executed, can be used to present wagering games upon which monetary value may be wagered. Such games include video poker, video black jack, video slots, video lottery, etc.

The media images 132, including wagering game machine software, may alternatively, or in addition, be stored in a mass storage unit 130, which may comprise one or more mass storage devices 144, including a disk drive, such as a hard disk drive or an optical disc drive (e.g., a compact disc, read-only memory disc drive), a flash memory drive, or some combination of these.

The static image 142 may comprise one or more separate images, alone or in combination. The static image comprises information resident within the gaming machine, either stored permanently in ROMs and/or in other non-volatile media, and/or stored temporarily, in volatile media, such as in random access memory (RAM). For example, in some embodiments, a downloaded image alone may constitute the static image. In some embodiments, the BIOS and SPI jurisdiction ROMs together may form the static image.

In some embodiments, the static image 142 may comprise an image of the BIOS ROM and an image of the SPI jurisdiction ROM, and/or other images stored in the apparatus 106 (e.g., a media image 132 of the wagering game machine software). The static image 142 may be stored in the memory 128, the storage unit 130, or elsewhere (e.g., on a wagering game server).

Thus, in some embodiments, the images that might otherwise be included in a BIOS ROM or SPI ROM are instead downloaded into volatile or nonvolatile memory, as desired, to form part of the static image. In some embodiments, the static image may comprise a file image downloaded from a gaming server, including a BIOS ROM image, or a SPI jurisdictional ROM image, alone or in combination. The signatures corresponding to the images may be downloaded with the images themselves, or separately calculated and stored after downloading is complete.

The CPU 126 may also be connected to an input/output (I/O) bus 122, which facilitates communication between the components of the apparatus 106. The I/O bus 122 may be connected to a payout mechanism 108, a primary display 110, a secondary display 112, a value input device 114, a player input device 116, an information reader 118, and the storage unit 130. The bus 122 may include one or more portions, any one or more of which may comprise a USB. Thus, any of the components coupled to the bus 122 may comprise USB peripherals 156.

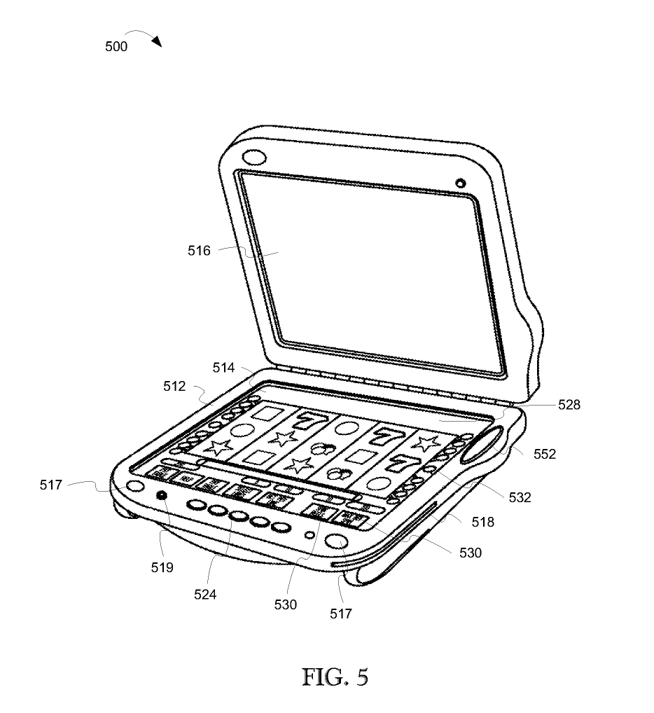

The player input device 116 can include the value input device 114 to the extent the player input device 116 is used to place wagers. The I/O bus 122 may be connected to an external system interface 124, which can be coupled to external systems 104 (e.g., wired and wireless wagering game networks). The external system interface 124 may comprise a network interface card and/or a wireless transceiver that enables the apparatus 106 to communicate with wired and/or wireless networks 164 respectively. Thus, the apparatus 106 may comprise a portable wagering game machine having a wireless transceiver (e.g., see FIG. 5).

In one embodiment, the apparatus 106 can include additional peripheral devices and/or more than one of each component shown in FIG. 1. For example, in one embodiment, the apparatus 106 can include multiple external system interfaces 124 and multiple processors 126. In one embodiment, any of the components can be integrated or subdivided. Additionally, in one embodiment, the components of the apparatus 106 can be interconnected according to any suitable interconnection architecture (e.g., directly connected, serially connected, star network, hypercube, etc.).

In one embodiment, any of the components of the apparatus 106 can include hardware, firmware, and/or software for performing the operations described herein. Thus, some embodiments may include an article of manufacture comprising a non-transitory machine readable medium having instructions stored thereon, wherein the instructions, when executed by one or more processors, result in performing any of the methods described herein. Machine-readable media include any mechanism that provides (e.g., stores) information in a form readable by a machine (e.g., a wagering game machine, computer, etc.). For example, tangible machine-readable media includes read only memory (ROM), random access memory (RAM), magnetic disk storage media, optical storage media, flash memory drives, etc. Thus, many embodiments may be realized.

For example, an apparatus 106, perhaps forming part of a wagering game machine, may comprise one or more processors 126 and media images 132, including a software program which, when executed by the processor(s) 126, results in presenting a wagering game upon which monetary value may be wagered. Thus, various embodiments may be realized.

For example, an apparatus 106 may comprise one or more processors 126 operable to present a wagering game upon which monetary value may be wagered. The apparatus 106 may further comprise a plurality of hardware components (e.g., any one or more of the aforementioned payout mechanism 108, displays 110, 112, value input device 114, player input device 116, information reader 118, storage unit 130, USB peripherals 156, among others. The apparatus 106 may further comprise a storage medium 140 storing a static image 142, the medium 140 being communicatively coupled to the processors 126. In many embodiments, the apparatus 106 comprises a signature image generation module 148 to generate a signature image 154 as a combination of at least one signature associated with the static image 142 stored in the storage medium 144 and/or a sorted list 152 of signatures, some of the signatures in the sorted list 152 being hardware signatures 170 (e.g., a unique identifier IDXX) associated with corresponding ones of the plurality of hardware components. Operation of the wagering game machine is permitted to proceed to a baseline configuration state in some embodiments when the signature image 154 matches an image associated with the baseline configuration state of the wagering game machine (e.g., a baseline configuration image stored in the apparatus 106, or on a wagering game server, or elsewhere).

The hardware components may comprise any component used in the apparatus 106 that can be associated with a signature, including a globally unique identifier (GUID) assigned by the manufacturer. Thus, the hardware components might comprise one or more of a value input device 114, a player input device 116, a primary display 110, a printer, or an information reader 118 in some embodiments.

The main memory 128 and the storage unit 130 include storage media that may comprise any number of devices, including volatile storage 136, and non-volatile storage 140, as well as combinations of these. Any information that is stored in the main memory 128 may be stored in the storage unit 130, and vice versa. Thus, in an embodiment, the medium 140 comprises at least two separate ROM storage devices communicatively coupled to the CPU 126, wherein the at least one signature associated with the static image 142 comprises separate signatures associated with each one of the at least two separate ROM storage devices.

For example, the storage medium 140 can be used to store the BIOS ROM and jurisdictional SPI ROM images in separate devices. Thus, a first portion of the static image 142 may comprise a BIOS image stored in a first one of two ROM storage devices, and a second portion of the static image may comprise a jurisdiction verification memory image stored in a second one of the ROM storage devices

The apparatus 106 may include a memory to store non-duplicated signatures in the sorted list. Thus, the apparatus 106 may comprise a memory 140 to store the sorted list 152 comprising non-duplicated signatures.

The wagering game machine can store all of the images and/or signatures needed to independently generate the signature image. Thus, the apparatus 106 may comprise a memory 140 to store one or more signatures associated with the static image 142 and the signatures contained in the sorted list 152, and/or the signature image 154.

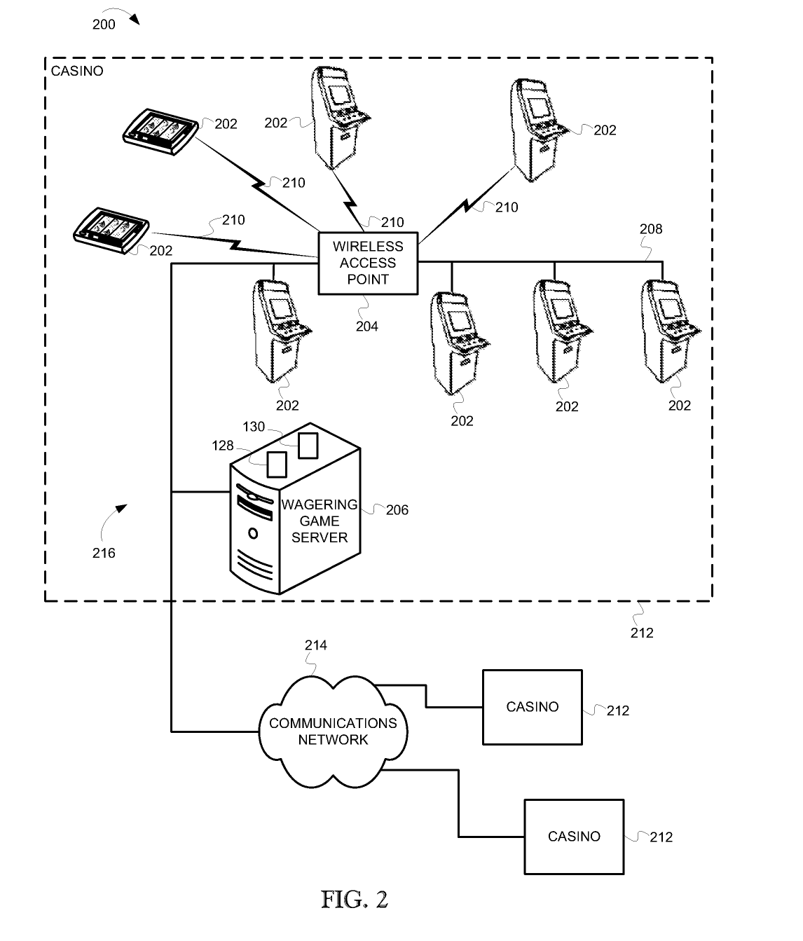

While FIG. 1 describes several embodiments of a wagering game machine architecture 100, FIG. 2 shows how a plurality of wagering game machines can be connected in a wagering game network.

### Example Wagering Game Network

FIG. 2 is a block diagram illustrating a wagering game network 200, according to various embodiments of the invention. As shown in FIG. 2, the wagering game network 200 includes a plurality of casinos 212 connected to a communications network 214.

Each of the plurality of casinos 212 includes a local area network 216, which may include wireless access points 204, wagering game machines 202, and a wagering game server 206 that can serve wagering games over the local area network 216. As such, the local area network 216 includes wireless communication links 210 and wired communication links 208. The wired and wireless communication links 208, 210 can employ any suitable connection technology, such as Bluetooth, I.E.E.E. 802.11, Ethernet, public switched telephone networks, SONET, etc. In one embodiment, the wagering game server 206 can serve wagering games and/or distribute content to devices located in other casinos 212 or at other locations on the communications network 214.

The wagering game machines 202 and wagering game server 206 can include hardware and machine-readable media including instructions for performing any of the operations described herein. The wagering game machines 202 may be similar to or identical to the apparatus 106 shown in FIG. 1.

The wagering game machines 202 described herein can take any suitable form, such as floor standing models, handheld mobile units, table top models, workstation-type console models, etc. Further, the wagering game machines 202 can be primarily dedicated for use in conducting wagering games, or can include non-dedicated devices, such as mobile phones, personal digital assistants, personal computers, etc. In one embodiment, the wagering game network 200 can include other network devices, such as accounting servers, wide area progressive servers, and player tracking servers.

In various embodiments, wagering game machines 202 and wagering game servers 206 work together such that a wagering game machine 202 may be operated as a thin, thick, or intermediate client. For example, one or more elements of game play may be controlled by the wagering game machine 202 (client) or the wagering game server 206 (server). Game play elements may include executable game code, lookup tables, configuration files, game outcome, audio or visual representations of the game, game assets or the like. In a thin-client example, the wagering game server 206 may perform functions such as determining game outcome or managing assets, while the wagering game machine 202 may be used merely to present the graphical representation of such outcome or asset modification to the user (e.g., player). In a thick-client example, game outcome may be determined locally (e.g., at the wagering game machine 202) and then communicated to the wagering game server 206 for recording or managing a player's account. In some embodiments, the wagering game machines 202 are operated as virtual machines, hosted on a server 206.

Similarly, functionality not directly related to game play may be controlled by the wagering game machine 202 (client) or the wagering game server 206 (server) in some embodiments. For example, power conservation controls that manage a display screen's light intensity may be managed centrally (e.g., by the wagering game server 206) or locally (e.g., by the wagering game machine 202). Other functionality not directly related to game play may include advertising presentation, software or firmware updates, system quality or security checks, etc. In some embodiments, the server 206 may be used to store independent copies of any of the images, signatures, or tables contained in the main memory 128 and/or mass storage unit 130 of one or more of the wagering game machines 202.

Thus, other embodiments may be realized. For example, a wagering game system may comprise one or more wagering game machines 202, each of which may be configured to operate in a manner similar to or identical to the apparatus 106 of FIG. 1. The system may include one or more wagering game servers 206 communicatively coupled to the wagering game machines 202, perhaps via networks 208, 210. The system may also comprise one or more signature image generation modules 148, configured to operate as described previously. The signature image generation module 148 may be included in the wagering game server 206 and/or the wagering game machines 202.

Referring now to FIGS. 1 and 2, it can be seen that the server 206 can be used to store all of the images and/or signatures needed to independently generate the signature image (see element 154 of FIG. 1). Thus, the system may comprise a memory (e.g., memory 140) to store signatures associated with the static image 142 and the signatures contained in the sorted list 152, and/or the signature image 154.

### Example Operations

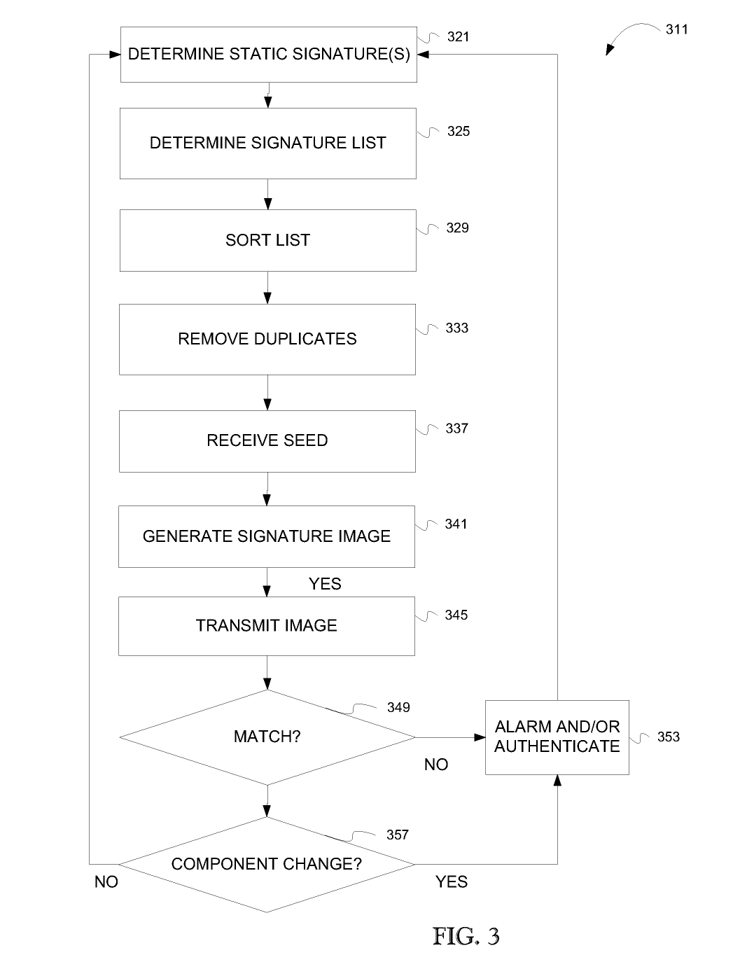

FIG. 3 is a flow chart illustrating methods 311 according to various embodiments. In some embodiments, the method 311 comprises determining a signature for a static image stored in memory (i.e., an image downloaded to a memory, and/or a BIOS ROM and/or a SPI ROM), and generating the signature image by combining the determined static image signature with a sorted list of hardware/software signatures.

For the purposes of this document, a “signature” is defined as the output from a processing method which produces a reproducible, verifiable and substantially unique (i.e., less than one chance in 10⁹ of a collision or duplicate) output data for given input data. A signature may be pre-calculated and stored along with or inside the associated image data, or determined at runtime. Authenticity may be added to a signature using an authentication method, such as the method documented by Digital Signature Standard (DSS) FIPS (Federal Information Processing Standards) PUB 186-3, Information Technology Laboratory, National Institute of Standards and Technology, June 2009. Thus many embodiments may be realized.

For example, a method 311 of managing signatures for components included in wagering game machines may begin at block 321 with determining at least one signature associated with a static image stored in a storage medium housed within a wagering game machine, where the machine is operable to present a wagering game.

The activity at block 321 may therefore comprise extracting a first signature associated with a first portion of the static image comprising a BIOS image stored in at least one first storage device, and extracting a second signature associated with at least a second portion of the static image comprising a jurisdiction verification memory image (e.g., a SPI jurisdiction ROM image) stored in at least one second storage device.

The signature of the static image may be, or include a hash value. Thus, one or more signatures associated with the static image may comprise a hash of a ROM signature image.

The static image signature(s) may eventually be included, along with other signatures, in a signature list. The other signatures may comprise signatures associated with game images, downloadable firmware, and/or configuration data. Thus, the method 311 may continue on to block 325 to include constructing or otherwise determining membership in the signature list.

The list may be constructed, for example, by extracting additional signatures associated with image content, wherein the image content is accessible to the wagering game machine (e.g., directly accessible as stored content, or indirectly accessible, as trusted downloadable content).

The image content may comprise instructions that can be executed by a processor in the wagering game machine. Accessible image content may include game images. Thus, the image content may include one or more game images corresponding to the wagering game to be presented by the wagering game machine. Further activity at block 325 may include adding the additional signatures to the list, either before or after the list is sorted.

An unsorted list of hardware and software image signatures can therefore be sorted to provide the sorted list. Thus, the activity at block 325 may include aggregating an unsorted list of signatures, including hardware signatures and additional signatures associated with image content accessible to the wagering gaming machine.

The method 311 may continue on to block 329 with sorting the unsorted list to provide the sorted list. Duplicate signatures can be removed from the list of signatures, prior to, during, or after the list is sorted. Thus, the method 311 may continue on to block 333 to include removing duplicate signatures from at least one of the sorted list, or an unsorted list that can be sorted to provide the sorted list. None of the activities shown in FIG. 3 is necessarily order-dependent unless specifically claimed to be so, including the activities described with respect to blocks 329 and 333.

The method 311 may include providing a seed value to a wagering game machine, to be used to generate the signature image. Thus, the method 311 may continue on to block 337 to include receiving a seed value from one of a wagering game server or an administration, operation, and maintenance server to be used in generating the signature image.

The method 311 may continue on to block 341 with generating (perhaps repetitively) a signature image comprising the sorted list of signatures and/or a combination of the sorted list and the signature(s) associated with the static image. Some of the signatures in the sorted list may comprise a plurality of hardware signatures associated with a corresponding plurality of hardware components physically attached to the wagering game machine. The activity in block 341 may include condensing the signature image even further, using various algorithms, such as by generating a seeded SHA1 or DSS of the sorted list of signatures, or a combination of the sorted list and signature(s) associated with the static image.

A combination of images may be formed by concatenating the static image signature(s) with the sorted list of signatures. Thus, the activity at block 341 may comprise concatenating the sorted list of signatures and the signature(s) associated with the static image to provide the combination, which may in turn serve as the signature image.

Signature images can be generated and used for baseline comparison purposes. Thus, the signature image can be sent to a gaming server or to other gaming machines as a baseline for comparison with signature images that are generated in the future. Therefore, the method 311 may include transmitting the signature image to a gaming server to be stored as a baseline image at block 345.

If the signature image does not conform to a pre-defined baseline configuration state of the machine, an alarm can be raised, and/or hardware/software can be authenticated to determine whether an updated configuration state should be established as a new baseline. Thus, the method 311 may continue on to block 349 to determine whether the signature image matches a baseline signature image configuration.

When the signature image does not match an image associated with the baseline configuration state of the wagering game machine, the method 311 may go on to block 353 to include at least one of providing an alarm indication or conducting authentication operations over hardware and/or software located within the wagering game machine to determine an updated configuration state of the wagering game machine.

At block 357, an independent determination can be made as to whether any specific components (hardware, firmware, or software) have been added, removed, or substituted within a given wagering game machine. For example, registers in an attached device may be programmed to determine whether the device is operating as expected. If not, then this may indicate the device has been changed, such as when the device has been removed from the machine. When this occurs, the method 311 may continue on to block 353. Otherwise, if independent checks do not reveal any changes, then the method 311 may return to block 321.

As noted previously, unless specifically claimed otherwise, the methods described herein do not have to be executed in the order described, or in any particular order. Moreover, various activities described with respect to the methods identified herein can be executed in iterative, repetitive, serial, or parallel fashion. Information, including parameters, commands, operands, and other data, can be sent and received in the form of one or more carrier waves.

### Example Wagering Game Machines

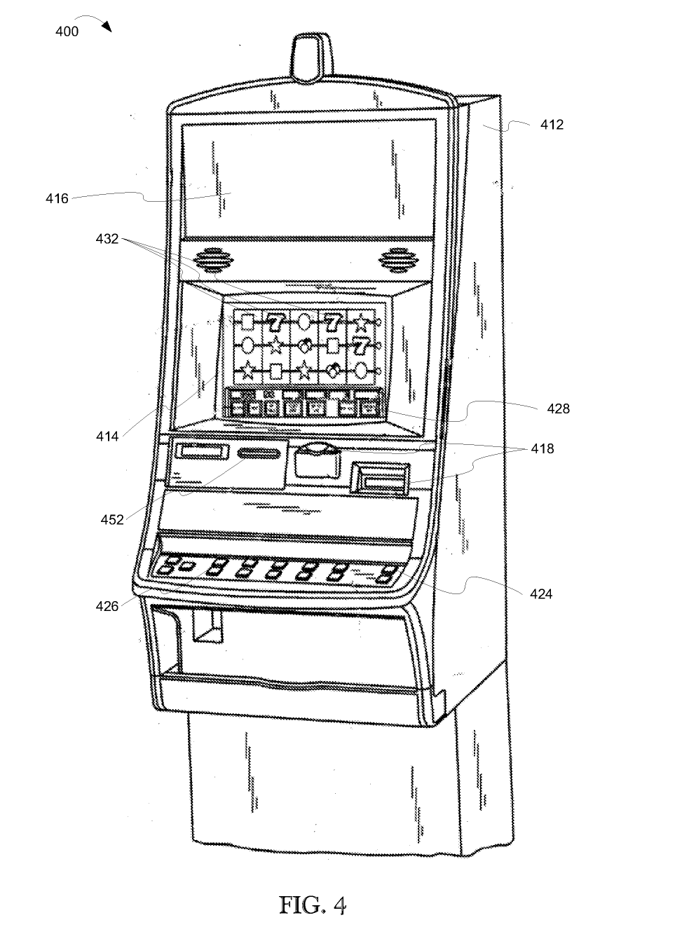

FIG. 4 is a perspective view of a wagering game machine 400, according to various embodiments of the invention. Referring to FIG. 4, a wagering game machine 400 is used in gaming establishments, such as casinos. According to most embodiments, the wagering game machine 400 can be any type of wagering game machine and can have varying structures and methods of operation. For example, the wagering game machine 400 can be an electromechanical wagering game machine configured to play mechanical slots, or it can be an electronic wagering game machine configured to play video casino games, such as blackjack, slots, keno, poker, blackjack, roulette, etc. The wagering game machine 400 may include one or more of the apparatus 106 of FIG. 1, and may be used in a network in the same way as the machines 202 of FIG. 2.

The wagering game machine 400 comprises a housing 412 and includes input devices, including value input devices 418 and a player input device 424. For output, the wagering game machine 400 includes a primary display 414 for displaying information about a basic wagering game. The primary display 414 can also display information about a bonus wagering game and a progressive wagering game. The wagering game machine 400 also includes a secondary display 416 for displaying wagering game events, wagering game outcomes, and/or signage information. While some components of the wagering game machine 400 are described herein, numerous other elements can exist and can be used in any number or combination to create varying forms of the wagering game machine 400.

The value input devices 418 can take any suitable form and can be located on the front of the housing 412. The value input devices 418 can receive currency and/or credits inserted by a player. The value input devices 418 can include coin acceptors for receiving coin currency and bill acceptors for receiving paper currency. Furthermore, the value input devices 418 can include ticket readers or barcode scanners for reading information stored on vouchers, cards, or other tangible portable storage devices. The vouchers or cards can authorize access to central accounts, which can transfer money to the wagering game machine 400.

The player input device 424 comprises a plurality of push buttons on a button panel 426 for operating the wagering game machine 400. In addition, or alternatively, the player input device 424 can comprise a touch screen 428 mounted over the primary display 414 and/or secondary display 416.

The various components of the wagering game machine 400 can be connected directly to, or contained within, the housing 412. Alternatively, some of the wagering game machine's components can be located outside of the housing 412, while being communicatively coupled with the wagering game machine 400 using any suitable wired or wireless communication technology.

The operation of the basic wagering game can be displayed to the player on the primary display 414. The primary display 414 can also display a bonus game associated with the basic wagering game. The primary display 414 can include a cathode ray tube (CRT), a high resolution liquid crystal display (LCD), a plasma display, light emitting diodes (LEDs), or any other type of display suitable for use in the wagering game machine 400. Alternatively, the primary display 414 can include a number of mechanical reels to display the outcome. In FIG. 4, the wagering game machine 400 is an “upright” version in which the primary display 414 is oriented vertically relative to the player. Alternatively, the wagering game machine can be a “slant-top” version in which the primary display 414 is slanted at about a thirty-degree angle toward the player of the wagering game machine 400. In yet another embodiment, the wagering game machine 400 can exhibit any suitable form factor, such as a free standing model, bar top model, mobile handheld model, or workstation console model.

A player begins playing a basic wagering game by making a wager via the value input device 418. The player can initiate play by using the player input device's buttons or touch screen 428. The basic game can include arranging a plurality of symbols along a payline 432, which indicates one or more outcomes of the basic game. Such outcomes can be randomly selected in response to player input. At least one of the outcomes, which can include any variation or combination of symbols, can trigger a bonus game.

In some embodiments, the wagering game machine 400 can also include an information reader 452, which can include a card reader, ticket reader, bar code scanner, RFID transceiver, or computer readable storage medium interface. In some embodiments, the information reader 452 can be used to award complimentary services, restore game assets, track player habits, etc.

FIG. 5 is a perspective view of a portable wagering game machine 500, according to various embodiments of the invention. Like free standing wagering game machines, in a handheld or mobile form, the wagering game machine 500 can include any suitable electronic device configured to play a video casino games such as blackjack, slots, keno, poker, blackjack, and roulette. The wagering game machine 500 may include one or more of the apparatus 106 of FIG. 1, and may be coupled to a network in the same manner as the machines 202 of FIG. 2.

The wagering game machine 500 comprises a housing 512 and includes input devices, including a value input device 518 and a player input device 524. For output, the wagering game machine 500 includes a primary display 514, a secondary display 516, one or more speakers 517, one or more player-accessible ports 519 (e.g., an audio output jack for headphones, a video headset jack, etc.), and other conventional I/O devices and ports, which may or may not be player-accessible. In the embodiment depicted in FIG. 5, the wagering game machine 500 comprises a secondary display 516 that is rotatable relative to the primary display 514. The optional secondary display 516 can be fixed, movable, and/or detachable/attachable relative to the primary display 514. Either the primary display 514 and/or secondary display 516 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and wagering game machine status.

The player-accessible value input device 518 can comprise, for example, a slot located on the front, side, or top of the housing 512 configured to receive credit from a stored-value card (e.g., casino card, smart card, debit card, credit card, etc.) inserted by a player. The player-accessible value input device 518 can also comprise a sensor (e.g., an RF sensor) configured to sense a signal (e.g., an RF signal) output by a transmitter (e.g., an RF transmitter) carried by a player. The player-accessible value input device 518 can also or alternatively include a ticket reader, or barcode scanner, for reading information stored on a credit ticket, a card, or other tangible portable credit or funds storage device. The credit ticket or card can also authorize access to a central account, which can transfer money to the wagering game machine 500.

Still other player-accessible value input devices 518 can require the use of touch keys 530 on the touch-screen display (e.g., primary display 514 and/or secondary display 516) or player input devices 524. Upon entry of player identification information and, preferably, secondary authorization information (e.g., a password, PIN number, stored value card number, predefined key sequences, etc.), the player can be permitted to access a player's account. As one potential optional security feature, the wagering game machine 500 can be configured to permit a player to access only accounts the player has specifically set up for the wagering game machine 500. Other security features can also be utilized, for example, to prevent unauthorized access to a player's account, to minimize an impact of any unauthorized access to a player's account, or to prevent unauthorized access to any personal information or funds temporarily stored on the wagering game machine 500.

The player input device 524 comprises a plurality of push buttons on a button panel for operating the wagering game machine 500. In addition, or alternatively, the player input device 524 can comprise a touch screen mounted to a primary display 514 and/or secondary display 516. In one aspect, the touch screen is matched to a display screen having one or more selectable touch keys 530 selectable by a user's touching of the associated area of the screen using a finger or a tool, such as a stylus pointer. A player enables a desired function either by touching the touch screen at an appropriate touch key 530 or by pressing an appropriate push button on the button panel. The touch keys 530 can be used to implement the same functions as push buttons. Alternatively, the push buttons 532, can provide inputs for one aspect of the operating the game, while the touch keys 530 can allow for input needed for another aspect of the game. The various components of the wagering game machine 500 can be connected directly to, or contained within, the housing 512, as seen in FIG. 5, or can be located outside the housing 512 and connected to the housing 512 via a variety of wired (tethered) or wireless connection methods. Thus, the wagering game machine 500 can comprise a single unit or a plurality of interconnected (e.g., wireless connections) parts which can be arranged to suit a player's preferences.

The operation of the basic wagering game on the wagering game machine 500 is displayed to the player on the primary display 514. The primary display 514 can also display the bonus game associated with the basic wagering game. The primary display 514 preferably takes the form of a high resolution LCD, a plasma display, an LED, or any other type of display suitable for use in the wagering game machine 500. The size of the primary display 514 can vary from, for example, about a 2-3″ display to a 15″ or 17″ display. In at least some embodiments, the primary display 514 is a 7″-10″ display. In one embodiment, the size of the primary display can be increased. Optionally, coatings or removable films or sheets can be applied to the display to provide desired characteristics (e.g., privacy, anti-scratch, anti-glare, bacterially-resistant and anti-microbial films, etc.). In at least some embodiments, the primary display 514 and/or secondary display 516 can have a 15:9 aspect ratio or other aspect ratio (e.g., 4:3). The primary display 514 and/or secondary display 516 can also each have different resolutions, different color schemes, and different aspect ratios.

As with the free standing embodiments a wagering gaming machine, a player begins play of the basic wagering game on the wagering game machine 500 by making a wager (e.g., via the value input device 518 or an assignment of credits stored on the handheld gaming machine via the touch screen keys 530, player input device 524, or buttons 532) on the wagering game machine 500. In some embodiments, the basic game can comprise a plurality of symbols arranged in an array, and includes at least one payline 528 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 518 of the wagering game machine 500 can double as a player information reader 552 that allows for identification of a player by reading a card with information indicating the player's identity (e.g., reading a player's credit card, player ID card, smart card, etc.). The player information reader 552 can alternatively or also comprise a bar code scanner, RFID transceiver or computer readable storage medium interface. In one embodiment, the player information reader 552 comprises a biometric sensing device. Still further embodiments may be realized.

### Additional Processes

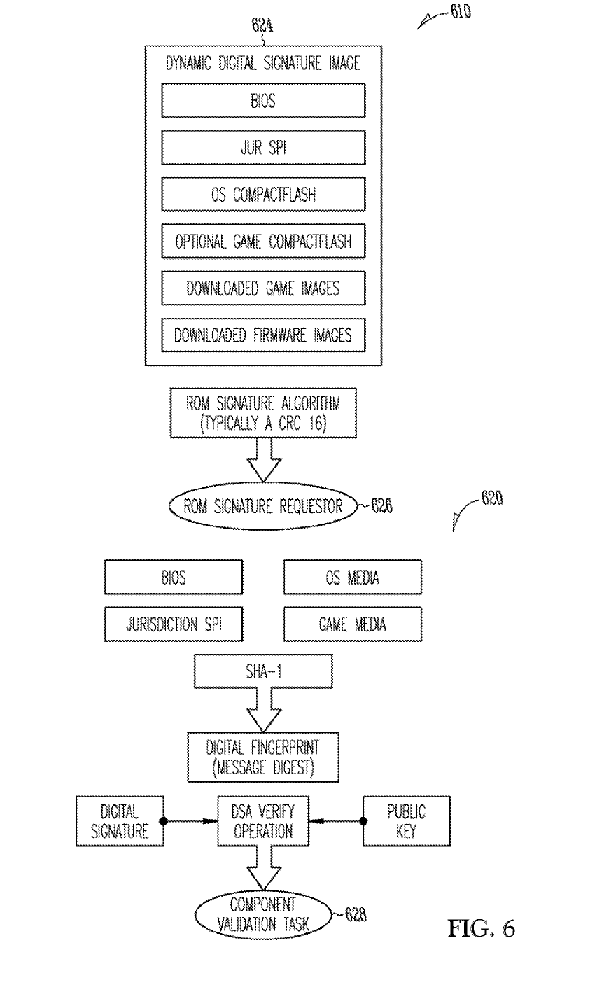

FIG. 6 is a diagram of processes 610, 620 for signature generation, verification, and validation according to various embodiments. In some embodiments, a wagering game machine can be configured to perform ROM signature calculation across the digital signature image 624, which may be similar to or identical to the image 154 of FIG. 1.

For example, in the process 610, a digital signature image can be generated by a wagering game machine and uploaded to a host computing system as a concatenation of the signature associated with each component (hardware, firmware, software) within the wagering game machine. Such components may include the BIOS ROM, the SPI jurisdiction ROM, and various images stored in flash memory, as well as the OS, wagering games, optional wagering game components, firmware images, and downloaded or injected images. The ROM signature requestor module 626 may reside on the host system, which may comprise a wagering game server (e.g., server 206 in FIG. 2).

In the process 620, the host system can operate to calculate a ROM signature based on a digital signature image as a component validation task 628 to ensure the integrity of a particular gaming machine. In some embodiments, the component validation task 628 operates to continually validate gaming machine components, indicating faults when any component validation operation fails.

In some embodiments, the amount of data used to calculate a ROM Signature result (e.g., using a CRC calculation) can be significantly reduced. This is accomplished by using a digital signature for each wagering game machine component that is limited to some consistent size, such as being limited to approximately forty bytes in length, regardless of the size of the component.

### General

Implementing the apparatus, systems, and methods disclosed herein may operate to verify and validate wagering game machine components, even when duplicate component images exist on the same machine. This can happen, for example, when a technician unintentionally downloads the same image twice (either forgetting that it has already been accomplished, or when the same file is made available to the technician with two different names). Other error scenarios exist, and the processes described herein can help maintain integrity by removing duplicate image signatures that may result. In this way, the security, integrity and authenticity of media components can be upheld for any combination of downloaded and physical media components. The presence of all such components can be continuously validated, even in the presence of ad-hoc firmware and software updates, without lengthy delays. Player satisfaction may be increased, and additional revenue for the owners of the machines may result.

In this detailed description, reference is made to specific examples by way of drawings and illustrations. These examples are described in sufficient detail to enable those skilled in the art to practice the inventive subject matter, and serve to illustrate how the inventive subject matter can be applied to various purposes or embodiments. Other embodiments are included within the inventive subject matter, as logical, mechanical, electrical, and other changes can be made to the example embodiments described herein. Features or limitations of various embodiments described herein, however essential to the example embodiments in which they are incorporated, do not limit the inventive subject matter as a whole, and any reference to the invention, its elements, operation, and application are not limiting as a whole, but serve only to define these example embodiments.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Description of the Embodiments, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into this detailed description, with each claim standing on its own as a separate embodiment.

1. A method, comprising:
repetitively generating a signature image comprising a sorted list of signatures, some of the signatures in the sorted list being hardware signatures associated with a corresponding plurality of hardware components physically attached to a wagering game machine operable to present a wagering game; and
enabling operation of the wagering game machine to proceed to a baseline configuration state when the signature image matches an image associated with the baseline configuration state of the wagering game machine.

2. The method of claim 1, further comprising:
concatenating the sorted list of signatures and at least one signature associated with a static image stored in a storage medium housed within the wagering game machine to provide the signature image.

3. The method of claim 2, further comprising determining the at least one signature by:
extracting a first signature associated with a first portion of the static image comprising a basic input-output system (BIOS) image stored in at least one first storage device; and
extracting a second signature associated with at least a second portion of the static image comprising a jurisdiction verification memory image stored in at least one second storage device.

4. The method of claim 1, further comprising:
extracting additional signatures associated with image content, the image content accessible to the wagering game machine and having instructions that can be executed by a processor in the wagering game machine; and
adding the additional signatures to an unsorted version of the sorted list.

5. The method of claim 1, further comprising:
aggregating an unsorted list of signatures including the hardware signatures and additional signatures associated with image content accessible to the wagering gaming machine; and
sorting the unsorted list to provide the sorted list.

6. The method of claim 5, wherein the image content includes at least one game image corresponding to the wagering game to be presented by the wagering game machine.

7. The method of claim 1, further comprising:
removing duplicate signatures from at least one of the sorted list, or an unsorted list that can be sorted to provide the sorted list.

8. The method of claim 1, further comprising:
when the signature image does not match the image associated with a baseline configuration state of the wagering game machine, at least one of providing an alarm indication or conducting authentication operations over hardware and/or software located within the wagering game machine to determine an updated configuration state of the wagering game machine.

9. The method of claim 1, further comprising:
transmitting the signature image to a gaming server to be stored as a baseline image.

10. A wagering game machine, comprising:
one or more processors operable to present a wagering game upon which monetary value may be wagered;
a plurality of hardware components;
a storage medium storing a static image and communicatively coupled to the one or more processors; and
a signature image generation module to generate a signature image as a sorted list of signatures, some of the signatures in the sorted list being hardware signatures associated with corresponding ones of the plurality of hardware components.

11. The machine of claim 10, wherein the plurality of hardware components comprise:
at least one of a value input device, a player input device, a primary display, a printer, or an information reader.

12. The machine of claim 10, wherein the storage medium comprises:
at least two separate read only memory storage devices communicatively coupled to the one or more processors, wherein at least one signature associated with a static image comprises separate signatures associated with each one of the at least two separate read only memory storage devices, and wherein the signature image comprises a combination of the sorted list of signatures and the at least one signature associated with the static image.

13. The machine of claim 12, wherein a first portion of the static image comprises a basic input-output system (BIOS) image stored in a first one of the read only memory storage devices, and wherein a second portion of the static image comprises a jurisdiction verification memory image stored in a second one of the read only memory storage devices

14. The machine of claim 10, further comprising:
a memory to store the sorted list comprising non-duplicated signatures.

15. A system, comprising:
a wagering game server;
a wagering game machine communicatively coupled to the wagering game server over a network, the wagering game machine having one or more processors operable to present a wagering game upon which monetary value may be wagered, the wagering game machine further comprising a plurality of hardware components and a storage medium storing a static image; and
a signature image generation module to generate a signature image as a sorted list of signatures, some of the signatures in the sorted list being hardware signatures associated with corresponding ones of the plurality of hardware components.

16. The system of claim 15, wherein the signature image generation module is included in the wagering game server.

17. The system of claim 15, further comprising:
a memory to store at least one signature associated with a static image and the signatures contained in the sorted list, or the signature image, wherein the signature image comprises a combination of the at least one signature associated with the static image.

18. A non-transitory storage medium to store instructions, which when executed by one or more processors result in a machine performing the method of:
repetitively generating a signature image comprising a sorted list of signatures, some of the signatures in the sorted list being hardware signatures associated with a corresponding plurality of hardware components physically attached to a wagering game machine operable to present a wagering game; and
enabling operation of the wagering game machine to proceed to a baseline configuration state when the signature image matches an image associated with the baseline configuration state of the wagering game machine.

19. The medium of claim 18, wherein the method further comprises:
receiving a seed value from one of a wagering game server or an administration, operation, and maintenance server to be used in generating the signature image.

20. The medium of claim 18, wherein the signature image comprises a combination of the sorted list and at least one signature associated with a static image, and wherein the at least one signature associated with the static image comprises a hash of a read only memory signature image.
